(19) United States
(12) Patent Application Publication
(10) Pub. No.: US 2012/0197462 A1
(43) Pub. Date: Aug. 2, 2012

(54) EMERGENCY REPORT APPARATUS

(75) Inventors: Hiroshi Sakai, Okazaki-city (JP); Koichi Masuda, Obu-city (JP)

(73) Assignee: DENSO CORPORATION, Kariya-city (JP)

(21) Appl. No.: 13/352,606

(22) Filed: Jan. 18, 2012

(30) Foreign Application Priority Data
Jan. 28, 2011 (JP) 2011-16411

(51) Int. Cl. G06F 7/00

(52) U.S. Cl. 701/1

(57) ABSTRACT

A portable device includes an airbag deployment determination unit that detects a deployment of an airbag, a travel condition detection unit that determines a travel condition of a vehicle, a travel condition determination unit that compares the travel condition before and after the detected deployment of the airbag to determine whether the travel condition has changed. Based on a comparison performed by the travel condition determination unit, an emergency report unit performs an emergency report operation, when the travel condition determination unit determines a change in the travel condition of the vehicle before and after the detected deployment of the airbag.

### CROSS REFERENCE TO RELATED APPLICATION

The present application is based on and claims the benefit of priority of Japanese Patent Application No. 2011-16411, filed on Jan. 28, 2011, the disclosure of which is incorporated herein by reference.

### TECHNICAL FIELD

The present disclosure generally relates to an emergency report apparatus which performs an emergency report operation when an airbag is deployed.

### BACKGROUND

A conventional, emergency report apparatus performs an emergency report operation when an electric deployment signal of an airbag is detected at a time of deployment. However, the deployment signal may vary from manufacture-to-manufacture (i.e., the deployment signal of one vehicle manufacture is in-compatible with the deployment signal of another).

As a result, the deployment of an airbag may be detected by a sound or pressure change in the vehicle that accompanies the deployment of the airbag. Such detection is disclosed in Japanese Patent Applications 2002-49981 ('981) and 2002-144994 ('994). However, in such configuration, misdetection of an airbag deployment may occur when the door of the vehicle is opened/closed to generate a sound or pressure change, and the airbag has not deployed, thereby leading to a false emergency report operation.

### SUMMARY

In view of the above and other problem, the present disclosure provides an emergency report apparatus which prevents an emergency report operation to be performed when such report operation is not required.

In the present disclosure, the emergency report apparatus may include: an airbag deployment determination unit for determining whether an airbag has been deployed; a travel condition detection unit for detecting a travel condition of a vehicle; a travel condition determination unit for determining whether the travel condition of the vehicle has changed by comparing the travel conditions detected by the travel condition detection unit before the airbag deployment determination unit detected the deployment of the airbag, and the travel condition detected by the travel condition detection unit after the airbag deployment determination unit determines the deployment of the airbag; and an emergency report unit for performing an emergency report operation when the travel condition determination unit determines that the travel condition before and after the deployment of the airbag has changed.

Accordingly, the emergency report operation is performed when the deployment of the airbag is detected, and the travel condition of the vehicle before and after the deployment of the airbag has changed. Therefore, the emergency report operation is not performed when the detected deployment of the airbag is not verified by a change in travel condition. As a result, false detections of an airbag deployment are not reported by the emergency report operation.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of an emergency report apparatus in an embodiment of the present disclosure; and

FIG. 2 is a flowchart of an emergency report process in the embodiment of the present disclosure.

### DETAILED DESCRIPTION

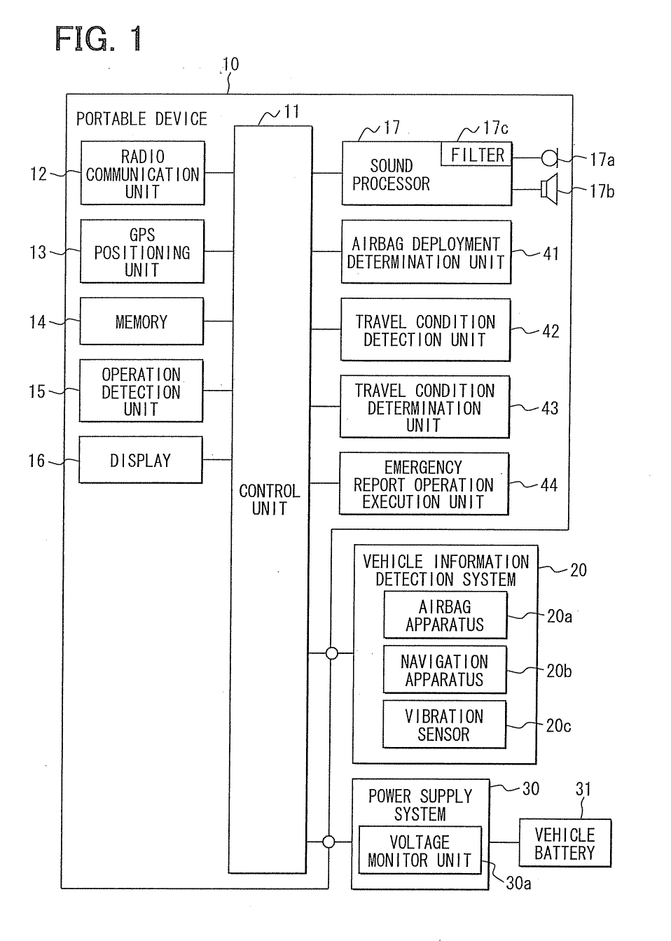

The present disclosure is explained as follows with reference to the drawings. With reference to FIG. 1, an emergency report apparatus 10 of the present disclosure may be implemented by an emergency call program, as described in the following, in a portable device. For example, the portable device may be a cellular phone, personal digital assistant, or the like. In the present embodiment, the emergency report apparatus 10 is designated as a portable device 10 in the following.

The portable device 10 includes a control unit 11, a radio communication unit 12, a GPS positioning unit 13, a storage unit 14, an operation detection unit 15, a display unit 16, and a sound processor 17. The control unit 11 includes a CPU, and controls the operation of the portable device 10. The radio communication unit 12 establishes a wireless communication channel with a base station of a cellular phone (not illustrated) outside of the vehicle, and transmits and receives various forms of data, such as sound data. The GPS positioning unit 13 receives a GPS signal transmitted by a GPS satellite (not illustrated), which is used to acquire the current position information of the portable device 10. The storage unit 14 includes a memory that is used to store information. The operation detection unit 15 outputs an operation detection signal to the control unit 11 according to a user's operation when it determines that the user has performed a predetermined operation through various operation buttons (not illustrated) of the portable device 10. The operation detection unit 15 transmits a signal to the control unit 11 indicating the operation selected by the user, and the control unit 11 performs such operation. The display unit 16, which may be in the form of a liquid crystal display panel, displays information to the user according to an instruction from the control unit 11.

The sound processor 17 processes sound data provided by a microphone 17a, and outputs it to a speaker 17b. The microphone 17a is used to detect vibration of the air in the vehicle, and, thus, is capable of detecting not only a sound in the vehicle but also pressure change in the vehicle. A filter 17c is provided for such microphone 17a. The filter 17c may be a band pass filter, which can pass a low frequency of at least 1 Hz. It may also be a call filter for general calls, which may pass a frequency of 300 to 3400 Hz.

The portable device 10 is coupled to a vehicle information detection system 20 and a power supply system 30, which are disposed in a vehicle, by way of a connection unit (not illustrated). The connection unit includes a communication detector that indicates whether the portable device 10 is coupled to the connection unit. The communication detector may be realized as a physical switch that is turned on when the portable device 10 is properly coupled with the connection unit. The communication detector may also be realized as a computer program or software. In either implementation, the control unit 11 of the portable device 10 determines that the portable device 10 is properly coupled to the connection unit when the communication detector is “on”. When the communication detector is “off” the control unit 11 determines that the portable device 10 is not coupled to the portable device connection unit. The state of “the portable device 10 is appropriately connected to the connection unit” means that the portable device 10 is coupled to the connection unit without falling off or pulling off so that vehicle information of various types and/or power supply are provided from the vehicle information detection system 20 and from the power supply system 30.

The vehicle information detection system 20 outputs various vehicle information to the control unit 11. The vehicle information detection system 20 monitors the various systems and components of the vehicle. For example, the vehicle information detection system 20 may monitor an engine control unit, a brake control unit, an acceleration sensor, a speed sensor, a seat sensor, an accessories switch, an ignition switch, a door switch, and the like.

The vehicle information detection system, as provided in FIG. 1, does monitor an airbag apparatus 20a, a navigation system 20b, and a vibration sensor 20c (i.e., a vibration detection unit in claims). When the portable device 10 is coupled to the vehicle information detection system 20, the vehicle information detection system 20 transmits data detected by the various devices, sensors, and switches of the vehicle to the control unit 11 of the portable device 10. It should be clear to one skilled in the art that the vehicle information detection system may monitor other systems and components of the vehicle.

The airbag apparatus 20a outputs an airbag deployment signal when an airbag is deployed based on a condition that an ignition switch of the vehicle is in “ON” position. The navigation system 20b is turned “ON” and “OFF” in synchronization with an ON/OFF of an accessory signal showing an ON/OFF condition of the accessories switch of the vehicle. The current position information provided by the navigation system 20b identifies a current position of the vehicle, and is different from the current position information from the GPS positioning unit 13, which identifies a current position of the portable device 10.

The vibration sensor 20c detects vibration of various components of the vehicle when the vehicle is traveling (e.g., body vibration to vibrate an entire vehicle body, chassis vibration to vibrate chassis of the vehicle, tire vibration generated by tires of the vehicle, and the like). In addition, the vibration sensor 20c may directly detect vibration components by using a speed sensor and/or an acceleration sensor (by analyzing frequency of the vibration, low frequency vibration is estimated as body/chassis vibration and high frequency vibration is estimated as tire/suspension vibration), or may indirectly detect vibration components (e.g., frequency, or pseudo vibration components) by calculation based on an accelerator pedal operation amount, a steering wheel operation amount, a brake operation amount, a tire speed, and the like. A vehicle specific vibration frequency, predetermined vehicle specific vibration frequency of various values may be prepared as data, or from sampling. Such data is employed to determine the source of the measured frequency, for the accurate detection of the travel condition of the vehicle, without being affected by the external disturbance/noise, regarding whether the vehicle is traveling or not.

The power supply system 30 supplies electric power from a vehicle battery 31 to the vehicle information detection system 20 and to the portable device 10 when the portable device is coupled to the connection unit. The power supply system 30 includes a voltage monitor apparatus 30a that monitors the voltage of the vehicle battery 31, and calculates an accumulated electric current, which is the total current flowing to each of the devices that the power supply system 30 provides power too.

The control unit 11 of the portable device 10 performs an emergency report process, which is stored in the CPU. The emergency report process can be provided or recognized as an airbag deployment determination unit 41, a travel condition detection unit 42, a travel condition determination unit 43, and an emergency report unit 44.

The airbag deployment determination unit 41 determines whether an airbag of the airbag apparatus 20a has been deployed by detecting a sound and pressure change in the vehicle with the use of the microphone 17a.

The travel condition detection unit 42 detects the travel condition of the vehicle. The travel condition detection unit 42 may employ various methods to determine the travel condition of the vehicle. For example, the travel condition of the vehicle can be determined by the portable device, such that when the portable device 10 is used in the vehicle, the vehicle is said to be in a traveling condition when the current position information of the portable device 10 acquired from the GPS positioning unit 13 indicates movement of the portable device 10. Further, the travel condition of the vehicle can be determined by the navigation system 20b, such that the vehicle is said to be in a traveling condition when the current position information acquired from the navigation system 20b indicates movement of the vehicle.

Furthermore, the vehicle may be said to be in a traveling condition when the speed of the vehicle detected from the speed sensor is equal to or above a predetermined traveling speed (i.e., a threshold speed that is normally considered as a traveling speed of the vehicle). Additionally, the travel condition of the vehicle can be determined by the vibration sensor 20c, such that when the vibration level of the vehicle is equal to or above a predetermined threshold the vehicle is determined to be traveling (i.e., vibration that is expected to be generated at various parts of the vehicle when the vehicle is traveling, such as the vehicle specific vibration and/or road noise during the travel of the vehicle). Further, the travel condition of the vehicle can be determined by the vehicle battery 31 and the voltage monitor apparatus 30a, such that the vehicle is said to be in a travel condition when the voltage monitor apparatus 30a has a value that is greater than a predetermined value (i.e., the voltage that is usually considered to indicate the travel of the vehicle). The travel condition detection method by the travel condition detection unit 42 is not necessarily limited to the above methods.

Based on the output of the air bag deployment determination unit 41 and the travel condition detection unit 41, the travel condition determination unit 43 determines whether the travel condition of the vehicle has changed, by comparing the travel condition of the vehicle before and after the deployment of the airbag.

The change in travel condition of the vehicle can be determined using the following methods or situations: (i) the current position information of the portable device 10, which was moving before the deployment of the airbag, is now still and is not moving after deployment, (ii) the current position information of the vehicle, which was traveling before the deployment of the air bag, is now not moving after deployment, (iii) the vehicle speed, which was maintained at a certain speed before the deployment of the airbag, steeply decreases to a speed smaller than a threshold travel speed after deployment, (iv) the travel acceleration value detected before the deployment of the airbag is no longer detected after the deployment, (v) a predetermined type of travel vibration that was detected before the deployment detection of the airbag is no longer detected after deployment, or (vi) the voltage of the vehicle battery 31 was maintained at a certain value, which is equal to or greater than the standard value, steeply decreases to a smaller-than-standard value after deployment. Other methods may also be implemented to determine a change of the vehicle's traveling condition.

The emergency report unit 44 performs a predetermined emergency report operation when the travel condition determination unit 43 determines that the travel condition of the vehicle has changed before and after the deployment of the airbag.

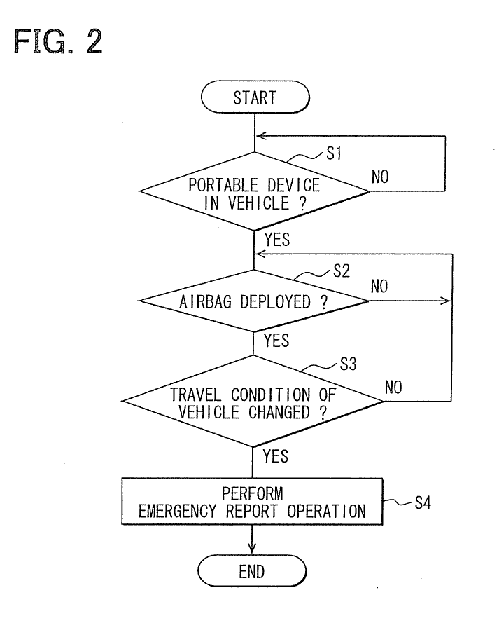

With reference now to FIG. 2, the emergency report process performed by the control unit 11 of the portable device 10 having the above-described configuration is explained in the following with reference to a flowchart in FIG. 2.

The process, in S1, detects whether the portable device 10 is coupled to the connection unit in the vehicle. When the portable device 10 is not detected (S1: NO), the process, continues to monitor the connection unit till the portable device 10 is detected. When the portable device 10 is detected (S1: YES), the process, in S2, determines whether the microphone 17a detects a deployment of the airbag. When the process determines that a deployment of the airbag has not been detected by the microphone 17a (S2: NO), the process continues to monitor the microphone by returning to S2. When the control unit 11 determines a deployment of the airbag was detected by the microphone 17a (S2: YES), the process, in step S3, verifies the deployment of the airbag by evaluating the travel condition of the vehicle before and after the detected deployment.

In S3, when the travel condition of the vehicle is unchanged before and after the deployment of the airbag (S3: NO), such as the vehicle is still traveling after the deployment of the airbag, the process returns to S2 to monitor microphone 17a. Accordingly, the process does not perform the emergency report operation (in S4).

When the travel condition of the vehicle has changed before and after the deployment of the airbag (S3: YES), the process proceeds to step S4 to perform the emergency report operation. The emergency report operation reports the current position information (i.e., the current position information of the portable device 10, the current position information of the vehicle) and/or vehicle ID information, together with other information, to an emergency station, such as 911 stations, or reports such information to a predetermined home telephone, a family-owned cellular phone, or the like. The emergency report operation is not necessarily limited to the above, and may be modified to include generally well-known usual emergency report operation.

According to the present embodiment, the emergency report operation is configured to be performed when the deployment of the airbag is detected and the travel condition of the vehicle has changed before and after the deployment of the airbag. In such configuration, even if the deployment of the airbag is detected, the emergency report operation will not be performed as long as the travel condition of the vehicle has not changed, which indicates that the detected airbag deployment was a false detection. Therefore, false emergency notifications by the emergency report operation are prevented.

Further, by utilizing the microphone 17a normally installed in the portable device 10 to determine whether the airbag of the airbag apparatus 20a is deployed, a new determination apparatus for determining whether the airbag of the airbag apparatus 20a has been deployed is not required, thereby simplifying the configuration of the emergency report apparatus.

The control unit 11 of the portable device 10 is configured to detect the travel condition of the vehicle based on the current position of the vehicle detected by the navigation system 20b by using the travel condition detection unit 42. Further, the control unit 11 of the portable device 10 is configured not to perform the emergency report operation by the emergency report unit 44 when it is determined that the vehicle is continuing the travel based on the travel condition detected by the travel condition detection unit 42.

In other words, when an accident happens to a vehicle, that is, when the emergency report is required, the travel condition (i.e., speed or acceleration) of the vehicle changes over (i.e., before and after) the deployment of the airbag. The present disclosure is designed to take such difference into account, and is characterized to have two phenomena of (i) “deployment of the airbag” and (ii) “travel condition of the vehicle has changed before and after the deployment of the airbag” as a trigger for performing the emergency report operation.

Therefore, the travel condition of the vehicle is detected by using the navigation system 20b installed in the vehicle. Further, even if the deployment of the airbag is falsely detected, if the vehicle continues its travel after such false detection, the emergency report operation is not performed. As a result, the unnecessary emergency report operation is prevented from being performed more securely, by using the navigation system 20b installed in the vehicle.

Accordingly, the control unit 11 of the portable device 10 is configured not to perform the emergency report operation by the emergency report unit 44, when, after a deployment of the airbag is detected by the airbag deployment determination unit 41, (i) movement of the current position information of the portable device 10 continues, (ii) movement of the current position information of the vehicle continues, (iii) the predetermined travel acceleration is being detected, (iv) the predetermined travel vibration is being detected by the vibration sensor 20, and/or (v) the voltage of the vehicle battery 31 is maintained to a value that is equal to or greater than the standard value. All of which indicate that the travel condition of the vehicle has not changed after the deployment of the airbag was detected.

A position detector, as provided in the claims, may be the GPS positioning unit 13 of the portable device 10 or the navigation system 20b of the vehicle.

Although the present disclosure has been fully described in connection with preferred embodiment thereof with reference to the accompanying drawings, it is to be noted that various changes and modifications will become apparent to those skilled in the art.

The control unit 11 of the portable device 10 may be configured not to perform the emergency report operation (cf. step S4) by the emergency report unit 44, when the portable device 10 is not installed in the vehicle, or when the portable device 10 is not set to a drive mode. In such configuration, an unnecessary emergency report operation is prevented from being performed when the portable device 10 is not connected to the vehicle, or when the portable device 10 is not set to a drive mode (i.e., when, for example, the user carrying the portable device 10 is outside the vehicle), that is, when the emergency report operation is not required.

The travel condition of the vehicle may preferably be detected based on the current position information having higher accuracy from among the current position information acquired by the GPS positioning unit 13 of the portable device 10 and the current position information acquired by the navigation apparatus 20b.

Additionally, an emergency report unit (i.e. control unit 11) of the emergency report apparatus 10 is configured not to perform the emergency report process when the emergency report apparatus 10 is not coupled to the vehicle, or when the emergency report apparatus 10 is not set to a drive mode. In such manner, when the emergency report unit is not connected to the vehicle, or when the emergency report apparatus 10 is not set to a drive mode (e.g., when the emergency report apparatus is carried by a user who is standing at an outside of the vehicle). That is, when there is no need for the emergency report, the emergency report operation will be more securely prevented.

In addition, the emergency report unit of the emergency report apparatus 10 is configured not to perform the emergency report operation when a vibration detection unit in the vehicle is detecting vibration of the vehicle generated during a travel of the vehicle. In such manner, while the vibration generated during the travel of the vehicle is detected, that is, when the vehicle is continuing its travel without encountering an accident or the like, thereby having no need to have the emergency report, the emergency report operation will be more securely prevented.

Such changes, modifications, and summarized schemes are to be understood as being within the scope of the present disclosure as defined by appended claims.

What is claimed is:

1. An emergency report apparatus comprising:
an airbag deployment determination unit for detecting whether an airbag has been deployed;
a travel condition detection unit for detecting a travel condition of a vehicle;
a travel condition determination unit for determining whether the travel condition of the vehicle before and after the detected deployment of the airbag has changed by comparing the travel condition detected by the travel condition detection unit before the airbag deployment determination unit detected the deployment of the airbag and the travel condition detected by the travel condition detection unit and after the airbag deployment determination unit detected the deployment of the airbag; and
an emergency report unit for performing an emergency report operation when the travel condition determination unit determines that the travel condition before and after the detected deployment of the airbag has changed.

2. The emergency report apparatus of claim 1, further comprising:
a microphone of a portable device,
wherein the airbag deployment determination unit detects whether the airbag has been deployed by detecting sound or pressure change in association with the deployment of the airbag by using the microphone.

3. The emergency report apparatus of claim 1, further comprising:
a position detector for detecting a current position of the vehicle, wherein
the travel condition detection unit detects the travel condition of the vehicle based on the current position of the vehicle, and
the emergency report unit is configured not to perform the emergency report operation, when the vehicle is determined to be continuing a travel based on the travel condition of the vehicle detected by the travel condition detection unit.

4. The emergency report apparatus of claim 1, wherein
the emergency report unit is configured not to perform the emergency report operation when the emergency report apparatus is not coupled to the vehicle, or when the emergency report apparatus is not set to a drive mode.

5. The emergency report apparatus of claim 1, further comprising:
a vibration detection unit for detecting vibration of the vehicle generated during a travel of the vehicle,
wherein the emergency report unit is configured not to perform the emergency report operation when a vibration detection unit is detecting vibration of the vehicle after the deployment of the airbag.
